(19) United States
(12) Patent Application Publication
(10) Pub. No.: US 2010/0274995 A1
(43) Pub. Date: Oct. 28, 2010

(54) PROCESSOR AND METHOD OF CONTROLLING INSTRUCTION ISSUE IN PROCESSOR

(75) Inventor: Hideki MATSUYAMA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 12/765,563

(22) Filed: Apr. 22, 2010

(30) Foreign Application Priority Data
Apr. 24, 2009 (JP) 2009-106227

(51) Int. Cl. G06F 9/30

(52) U.S. Cl. 712/216; 712/E09.016

(57) ABSTRACT

One exemplary embodiment includes a processor including a plurality of execution units and an instruction unit. The instruction unit discriminates whether an instruction is a target instruction for which determination about availability of parallel issue based on dependency among instructions is to be made with respect to each instruction contained in an instruction stream. When a first instruction contained in the instruction stream is the target instruction, the instruction unit adjusts the number of instructions to be issued in parallel to the plurality of execution units based on a detection result of dependency among the first instruction and at least one subsequent instruction. Further, when the first instruction is not the target instruction, the instruction unit issues a group of a predetermined fixed number of instructions including the first instruction in parallel to the plurality of execution units unconditionally regardless of a detection result of dependency among the instruction group.

### INCORPORATION BY REFERENCE

This application is based upon and claims the benefit of priority from Japanese patent application No. 2009-106227, filed on Apr. 24, 2009, the disclosure of which is incorporated herein in its entirety by reference.

### BACKGROUND

1. Field of the Invention

The present invention relates to a processor with a superscalar architecture capable of simultaneous execution of a plurality of instructions.

2. Description of Related Art

A pipeline architecture is used to enhance the instruction execution performance of a processor. In the pipeline architecture, an instruction execution process is divided into a plurality of stages, and the respective stages are implemented by different hardware. The plurality of stages can perform processing related to separate instructions in parallel. Therefore, with the pipeline architecture, it is theoretically possible to execute one instruction in one clock cycle.

In order to further enhance the instruction execution performance of a processor and simultaneously execute a plurality of instruction in one clock cycle, parallel processing at the instruction level is further required. As a mechanism of a processor that enables simultaneous execution of a plurality of instructions in one clock cycle, superscalar and VLIW (Very Long Instruction Word) are known.

In the superscalar, a processor determines the availability of parallel issue by detecting the dependency among instructions and then simultaneously issues a plurality of instructions which are determined to be available for parallel issue to a plurality of execution units. The execution units may be a load/store unit, an integer arithmetic unit, a floating-point adder, a floating-point multiplier and so on, for example.

On the other hand, in the VLIW, a compiler analyzes the dependency among instructions at the time of generating an execution code and generates a VLIW instruction including a combination of instructions which can be issued in parallel. The VLIW instruction has a plurality of areas called packets or slots. Each packet (slot) corresponds to any one of execution units in a processor, and an instruction for controlling the corresponding execution unit is embedded in each slot. Once a processor decodes one VLIW instruction, it simultaneously issues instructions of a plurality of packets to a plurality of execution units without consideration of the dependency among packets (slots) included in the VLIW instruction. Because the instructions which can be issued in parallel are explicitly specified by the complier in the VLIW, a processor does not need to make determination about the availability of parallel issue based on the dependency among instructions. Thus, in the VLIW, a hardware configuration of an instruction issue unit can be simplified compared to the superscalar.

TAMAOKI (Japanese Unexamined Patent Application Publication No. 09-274567) discloses a processor capable of switching between VLIW mode and superscalar mode. The VLIW mode is an operation mode in which a processor does not make determination about the availability of simultaneous issue based on detection of the dependency among instructions. On the other hand, in the superscalar mode, the processor disclosed in TAMAOKI detects the dependency among instructions, selects instructions which can be issued simultaneously and issues the selected instructions to execution units.

Switching between the VLIW mode and the superscalar mode performed in the processor disclosed in TAMAOKI is made in response to switching of an execution program. For example, the operation mode is switched when an interrupt occurs during execution of an application program in the VLIW mode and the process branches to a system program for interrupt processing to be executed in the superscalar mode.

Further, the processor disclosed in TAMAOKI performs switching of the operation mode in response to switching of the execution program (execution process) under a multiprogramming (multiprocess) environment. For example, the processor switches the operation mode from the VLIW mode to the superscalar mode at the time of switching the execution program from an application program compatible with the VLIW mode to an application program incompatible with the VLIW mode and to be executed in the superscalar mode.

As described above, the processor disclosed in TAMAOKI switches the operation mode concomitantly with program switching. Thus, at the time of mode switching, the processor disclosed in TAMAOKI suspends fetch, decode and issue to an arithmetic unit of new instructions and waits for completion of the instruction already issued to each execution unit before mode switching and being executed. Then, when there becomes no instruction being executed, the processor disclosed in TAMAOKI updates PSW (Program Status Word) so as to be compatible with a program after mode switching, switches the operation of dependency detection hardware, and then starts fetch of instructions of the program after mode switching.

### SUMMARY

The processor disclosed in TAMAOKI performs switching of the operation mode concomitantly with switching of the execution program. Thus, the present inventor has found a problem that an instruction execution suspension period at the time of mode switching is long in the processor disclosed in TAMAOKI. For example, when switching from the VLIW mode to the superscalar mode, fetch and decode of instructions to be executed in the superscalar mode are not started until an instruction issued in the VLIW mode is completed. The long instruction execution suspension period hampers the improvement of the instruction execution performance, which is not preferable.

A first exemplary aspect of the present invention includes a processor. The processor includes a plurality of execution units and an instruction unit. The instruction unit is configured to decode an instruction stream and perform instruction issue processing to the plurality of execution units. The instruction issue processing includes the following processing (a) to (c):
(a) discriminating whether an instruction is a target instruction for which determination about availability of parallel issue based on dependency among instructions is to be made with respect to each instruction contained in the instruction stream;
(b) when a first instruction contained in the instruction stream is the target instruction, adjusting the number of instructions to be issued in parallel to the plurality of execution units based on a detection result of dependency among the first instruction and at least one subsequent instruction; and
(c) when the first instruction is not the target instruction, issuing an instruction group made up of a predetermined fixed number of instructions including the first instruction in parallel to the plurality of execution units unconditionally regardless of a detection result of dependency among the instruction group.

A second exemplary aspect of the present invention includes a method of controlling instruction issue to a plurality of execution units included in a processor. The method includes the following steps (a) to (c):
(a) discriminating whether an instruction is a target instruction for which determination about availability of parallel issue based on dependency among instructions is to be made with respect to each instruction contained in an instruction stream;
(b) when a first instruction contained in the instruction stream is the target instruction, adjusting the number of instructions to be issued in parallel to the plurality of execution units based on a detection result of dependency among the first instruction and at least one subsequent instruction; and
(c) when the first instruction is not the target instruction, issuing an instruction group made up of a predetermined fixed number of instructions including the first instruction in parallel to the plurality of execution units unconditionally regardless of a detection result of dependency among the instruction group.

According to the exemplary aspects of the present invention described above, the processor can discriminate whether it is an instruction for which determination about the availability of parallel issue based on the dependency among instructions is necessary or not with respect to each instruction contained in one program (instruction stream). Further, the processor can switch between (i) operation of adjusting the number of instructions to be issued in parallel based on a detection result of the dependency among instructions and (ii) operation of unconditionally issuing a predetermined fixed number of instructions in parallel regardless of a detection result of the dependency among those instructions, according to a discrimination result regarding the necessity of determination about the availability of parallel issue.

Thus, according to the exemplary aspects of the present invention, the processor is capable of processing a program (instruction stream) that contains both instructions for which determination about the availability of parallel issue is necessary and instructions for which it is unnecessary, thus eliminating the need for program switch processing, which has been needed in the processor disclosed in TAMAOKI.

According to the exemplary aspects of the present invention described above, it is possible to process instructions for which determination about the availability of parallel issue is necessary and instructions for which it is unnecessary efficiently in succession without an instruction execution suspension period due to program switching, thus suppressing degradation of the instruction execution performance.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a configuration of a processor according to a first exemplary embodiment of the present invention;

FIG. 2 is a view showing an example of an operation code map according to the first exemplary embodiment of the present invention;

FIG. 3 is a view showing an instruction issue operation of the processor according to the first exemplary embodiment of the present invention;

FIG. 4 is a block diagram showing a configuration of a processor according to a second exemplary embodiment of the present invention;

FIG. 5 is a view showing an example of an operation code map according to the second exemplary embodiment of the present invention; and

FIG. 6 is a view showing an instruction issue operation of the processor according to the second exemplary embodiment of the present invention.

### DETAILED DESCRIPTION OF THE EXEMPLARY EMBODIMENTS

Exemplary embodiments of the present invention will be described hereinafter in detail with reference to the drawings. In the drawings, the identical reference symbols denote identical structural elements and the redundant explanation thereof is omitted as appropriate.

### First Exemplary Embodiment

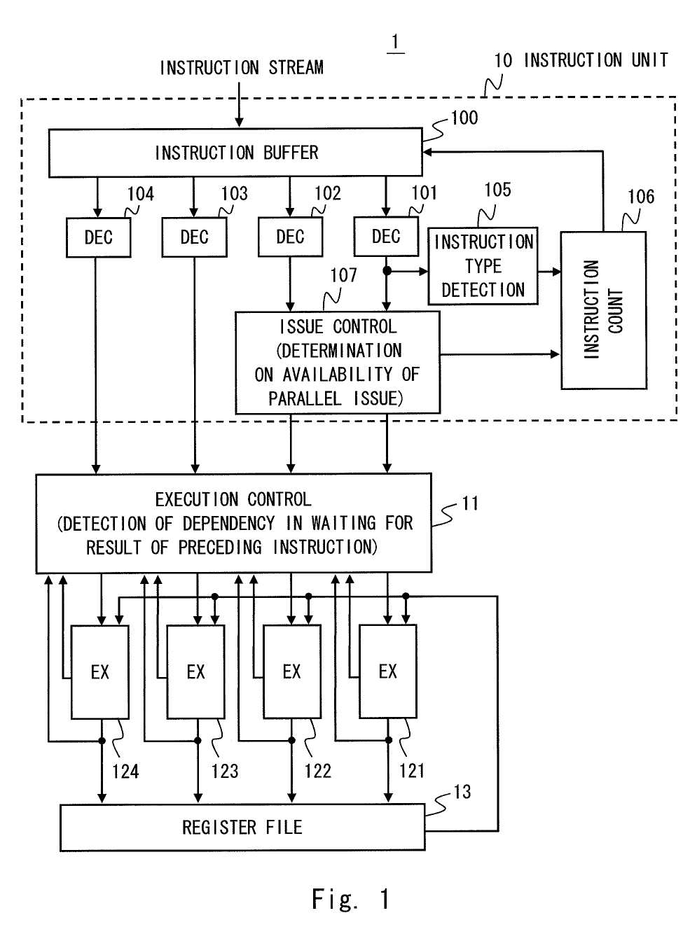

FIG. 1 is a block diagram showing an exemplary configuration of a processor 1. In the example of FIG. 1, the processor 1 includes an instruction unit 10 and four execution units 121 to 124.

An overview of an instruction issue operation by the instruction unit 10 is described firstly. The instruction unit 10 sequentially acquires instructions contained in an instruction stream and decodes the acquired instructions. Then, the instruction unit 10 decides the necessity of determination about the availability of parallel issue based on the dependency among instructions with respect to each decoded instruction. Hereinafter, an instruction for which determination about the availability of parallel issue is necessary is referred to as “normal instruction”, and an instruction for which determination about the availability of parallel issue is unnecessary is referred to as “non-normal instruction”. In this embodiment, different instruction codes (operation codes) are allocated to “normal instruction” and “non-normal instruction”. The instruction unit 10 may distinguish between “normal instruction” and “non-normal instruction” by referring to the operation code of each instruction obtained by instruction decoding.

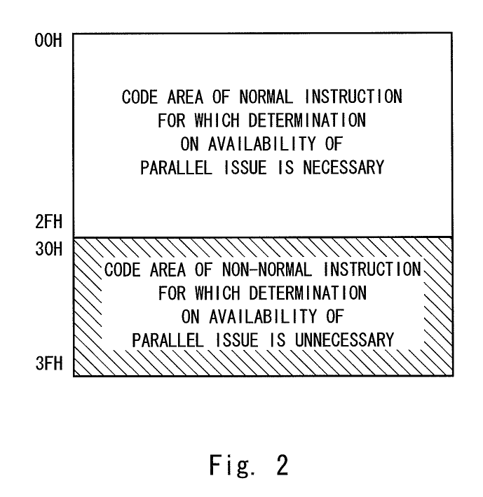

The operation code map shown in FIG. 2 shows an illustrative example of an operation code that is allocated to each instruction in an instruction stream supplied to the processor 1 when the number of operation code bits is six. In the example of FIG. 2, the anterior portion (00H to 2FH) of the operation code is allocated to “normal instruction”, and the posterior portion (30H to 3FH) of the operation code is allocated to “non-normal instruction”.

When the decoded instruction is “normal instruction”, the instruction unit 10 detects the dependency among the instruction and at least one subsequent instruction and adjusts the number of instructions to be issued in parallel with the instruction based on a detection result of the dependency. Note that the dependency among instructions related to the availability of parallel issue is specifically the dependency of operands. Thus, the dependency for the availability of parallel issue may be detected by comparing a source operand and a destination operand of each instruction.

In the example of FIG. 1, the instruction unit 10 detects the dependency between two instructions in total, i.e., the instruction determined to be “normal instruction” and one subsequent instruction. If it is determined that there is no dependency between the two instructions, the instruction unit 10 issues the two instructions in parallel to two of the execution units 121 to 124. If, on the other hand, it is determined that there is dependency between the two instructions, the instruction unit 10 issues only the instruction determined to be “normal instruction” to one of the execution units 121 to 124. In the case where an architecture in which out-of-order issue of instructions is allowable is employed, the instruction unit 10 may be configured to detect the dependency related to the availability of parallel issue among three or more instructions.

On the other hand, when the decoded instruction is “non-normal instruction”, the instruction unit 10 unconditionally issues four instructions in total including the instruction and three subsequent instructions in parallel to the four execution units 121 to 124 regardless of a detection result of the dependency among the four instructions.

The elements other than the instruction unit 10 shown in FIG. 1 are sequentially described hereinafter. An execution control unit 11 is placed between the instruction unit 10 and the execution units 121 to 124. The execution control unit 11 detects the dependency between instructions issued from the instruction unit 10 and a preceding instruction already being executed in the execution units 121 to 124. Specifically, the execution control unit 11 detects “the dependency in waiting for an execution result of the preceding instruction” which occurs when using a result of the preceding instruction for the subsequent instruction and causes execution of the subsequent instruction to wait in order to avoid so-called RAW (Read After Write) hazard. In order to reduce the waiting time of the subsequent instruction, a bypass circuit that supplies execution results of the execution units 121 to 124 to the execution control unit 11 may be placed to perform so-called forwarding.

The execution units 121 to 124 are computing units that execute processing according to instructions. The execution units 121 to 124 may be a load/store unit, an integer arithmetic unit, a floating-point adder, a floating-point multiplier and so on, for example.

A register file 13 includes registers that store input data to the execution units 121 to 124 and execution results of the execution units 121 to 124.

The elements included in the instruction unit 10 shown in FIG. 1 are described hereinbelow. An instruction buffer 100 stores an instruction stream sequentially acquired from an instruction cache (not shown). In this exemplary embodiment, each instruction in the instruction stream contains an operation code for discriminating which of “normal instruction” and “non-normal instruction” the instruction is.

Instruction decoders 101 to 104 read four instructions from the instruction buffer 100 according to a program execution sequence and decode the instructions. Two instructions in the first half which are decoded by the instruction decoders 101 and 102 are supplied to an issue control unit 107. The instruction decoders 103 and 104 decode two instructions in the latter half. The instruction decoders 103 and 104 are in one-to-one correspondence with the execution units 123 and 124, respectively. When the decoded instructions are “non-normal instruction” to be executed in the corresponding execution unit 123 or 124, the instruction decoders 103 and 104 supply the two instructions to the execution control unit 11. On the other hand, when the decoded instructions are “normal instruction” or when the decoded instructions are “non-normal instruction” to be executed in the execution units 121 and 122, the instruction decoders 103 and 104 inhibit the supply of the latter two instructions to the execution control unit 11.

An instruction type detection unit 105 determines whether the head instruction decoded by the decoder 101 is either “normal instruction” or “non-normal instruction”. A determination result by the detection unit 105 is supplied to an instruction count unit 106.

The instruction count unit 106 counts the number of instructions to be issued in parallel in the current clock cycle, eliminates the same number of instructions as the counted number of instructions from the instruction buffer 100, and fetches new instructions from an instruction cache (not shown). To be more precise, the instruction count unit 106 receives a determination result of either “normal instruction” or “non-normal instruction” from the instruction type detection unit 105. Further, the instruction count unit 106 receives the number of instructions which are determined to be available for parallel issue by the issue control unit 107. Based on those two information, the instruction count unit 106 determines which of one, two and four the number of instructions to be issued in parallel is. Specifically, when the instruction type detection unit 105 detects “non-normal instruction”, the instruction count unit 106 determines that the number of parallel issue instructions is four, regardless of a determination result about the availability of parallel issue by the issue control unit 107. On the other hand, when the instruction type detection unit 105 detects “normal instruction”, the instruction count unit 106 determines whether the number of parallel issue instructions is one or two according to a determination result about the availability of parallel issue by the issue control unit 107.

The issue control unit 107 detects the dependency between two instructions decoded by the instruction decoders 101 and 102 and determines the availability of parallel issue of the two instructions. The issue control unit 107 issues two instructions when it determines that parallel issue is available, and issues one instruction (the head instruction decoded by the decoder 101) when it determines that parallel issue is unavailable. Note that the issue control unit 107 may actively cancel the dependency between the instructions by performing register renaming so as to enable parallel issue of the two instructions as much as possible.

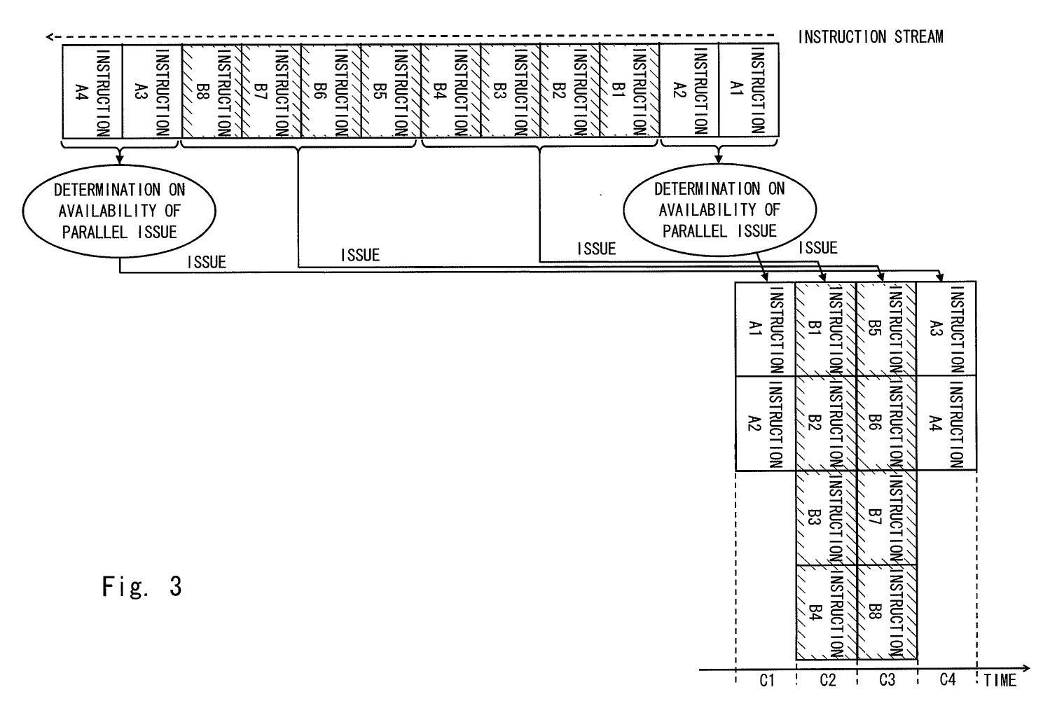

FIG. 3 is a view showing an exemplary operation of the processor 1 according to the exemplary embodiment. The processor 1 sequentially decodes instructions in an instruction stream and issues the decoded instructions in order. The instruction stream shown in FIG. 3 contains instructions A1 to A4 and instructions B1 to B8. Among those instructions, the instruction A1 at the right end in FIG. 3 is an instruction to be executed first. Further, the instructions A1 to A4 are instructions defined as “normal instruction” for which determination about the availability of parallel issue is necessary. The instructions B1 to B8 are instructions defined as “non-normal instruction” for which determination about the availability of parallel issue is unnecessary.

First, the instruction decoders 101 to 104 acquire and decode the instructions A1, A2, B1 and B2. It is assumed that the instructions B1 and B2 are instructions to be executed in one of the execution units 121 and 122. Because the instruction A1 is “normal instruction”, the issue control unit 107 determines the availability of parallel issue of the instructions A1 and A2 based on the dependency between operands of the instructions A1 and A2. In the example of FIG. 3, there is no dependency that constrains parallel issue between the instructions A1 and A2, and those two instructions are issued in parallel (clock cycle C1). On the other hand, the issue of the instructions B1 and B2 decoded by the instruction decoders 103 and 104 is inhibited. This is because the instructions B1 and B2 are not instructions to be executed in the execution unit 123 or 124. Consequently, the two instructions A1 and A2.are issued in parallel in the cycle C1. The instruction count unit 106 controls the instruction buffer 100 to fetch new instructions into the buffer area for two instructions, which are issued in this cycle.

Then, the instruction decoders 101 to 104 acquire and decode the instructions B1 to B4. It is assumed that the instructions B1 to B4 are instructions to be executed by the execution units 121 to 124, respectively. In this case, the instruction unit 10 unconditionally issues the four instructions (B1 to B4) in parallel (clock cycle C2). The instruction count unit 106 controls the instruction buffer 100 to fetch new instructions into the buffer area for four instructions, which are issued in this cycle. Note that the issue control unit 107 may operate to detect the dependency between the instructions B1 and B2, which are “non-normal instruction”. Because the dependency between the instructions B1 and B2 being “non-normal instruction” are already solved by a compiler, a determination result by the issue control unit 107 is always that parallel issue is available. Therefore, no particular problem occurs when the parallel issue operation by the issue control unit 107 is not suspended. The instruction unit 10 may be configured to suspend or bypass the determination operation by the issue control unit 107 when the instructions decoded by the instruction decoders 101 and 102 are “non-normal instruction”.

Then, the instruction decoders 101 to 104 acquire and decode the instructions B5 to B8. It is assumed that the instructions B5 to B8 are instructions to be executed by the execution units 121 to 124, respectively. In this case, the instruction unit 10 unconditionally issues the four instructions (B5 to B8) in parallel (clock cycle C3). The instruction count unit 106 controls the instruction buffer 100 to fetch new instructions into the buffer area for four instructions, which are issued in this cycle.

As described above, the processor 1 according to the exemplary embodiment can discriminate whether it is an instruction for which determination about the availability of parallel issue based on the dependency among instructions is necessary or not with respect to each instruction contained in one program (instruction stream). Further, the processor 1 can switch between (i) operation of adjusting the number of instructions to be issued in parallel based on a detection result of the dependency among instructions and (ii) operation of unconditionally issuing a predetermined fixed number of instructions in parallel regardless of a detection result of the dependency among those instructions, according to a discrimination result regarding the necessity of determination about the availability of parallel issue.

Thus, the processor 1 is capable of processing a program (instruction stream) that contains both instructions for which determination about the availability of parallel issue is necessary and instructions for which it is unnecessary, thus eliminating the need for program switch processing, which has been needed in the processor disclosed in TAMAOKI. The processor 1 can thereby process the instructions for which determination about the availability of parallel issue is necessary and the instructions for which it is unnecessary efficiently in succession without an instruction execution suspension period due to program switching, thus suppressing degradation of the instruction execution performance.

### Second Exemplary Embodiment

A processor 2 according to a second exemplary embodiment of the present invention adjusts the number of instructions to be issued in parallel based on whether the head instruction among a group of instructions that are decoded in each clock cycle is “non-normal instruction” or “non-normal instruction”. For example, the processor 2 performs decoding in units of four instructions in each clock cycle, and if the head instruction (first instruction) is “normal instruction”, unconditionally issues the four instructions regardless of whether the subsequent second to fourth instructions are “normal instruction” or “non-normal instruction”. Thus, the processor 2 performs switching between (i) operation of adjusting the number of instructions to be issued in parallel based on a detection result of the dependency among instructions and (ii) operation of unconditionally issuing a predetermined fixed number of instructions in parallel, based on a discrimination result of only one instruction (specifically, the head instruction) among an instruction group.

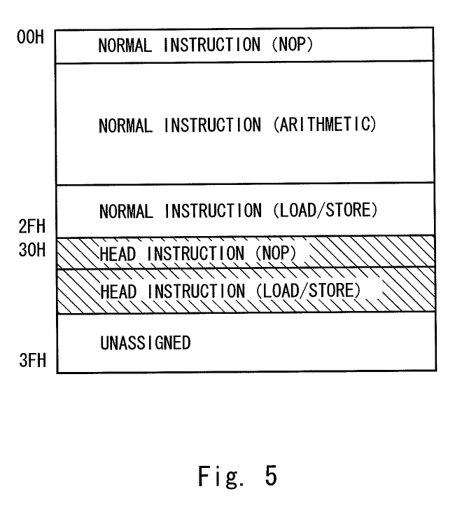

With the processor 2 operating in this manner, it is possible to improve the use efficiency of an operation code area to which “non-normal instruction” is allocated. An illustrative example of an operation code map in this exemplary embodiment is described hereinafter with reference to FIG. 5. The operation code map in FIG. 5 is different from that of FIG. 3 in that the number of instructions defined as “non-normal instruction” is reduced. This is because only one instruction among a group of instructions decoded simultaneously is defined as “non-normal instruction” in the processor 2 in this exemplary embodiment. For example, in the case of using a discrimination result of the head instruction among an instruction group made up of four instructions, “non-normal instruction” may be defined only for the instruction to be executed in an execution unit (e.g. the execution unit 121) corresponding to the instruction decoder 101 that decodes the head instruction. If, for example, the execution unit 121 is a load/store unit, only a load/store instruction and an NOP (No Operation) instruction are defined as “non-normal instruction”, and other instructions such as an add instruction and a multiply instruction are not defined as “non-normal instruction”.

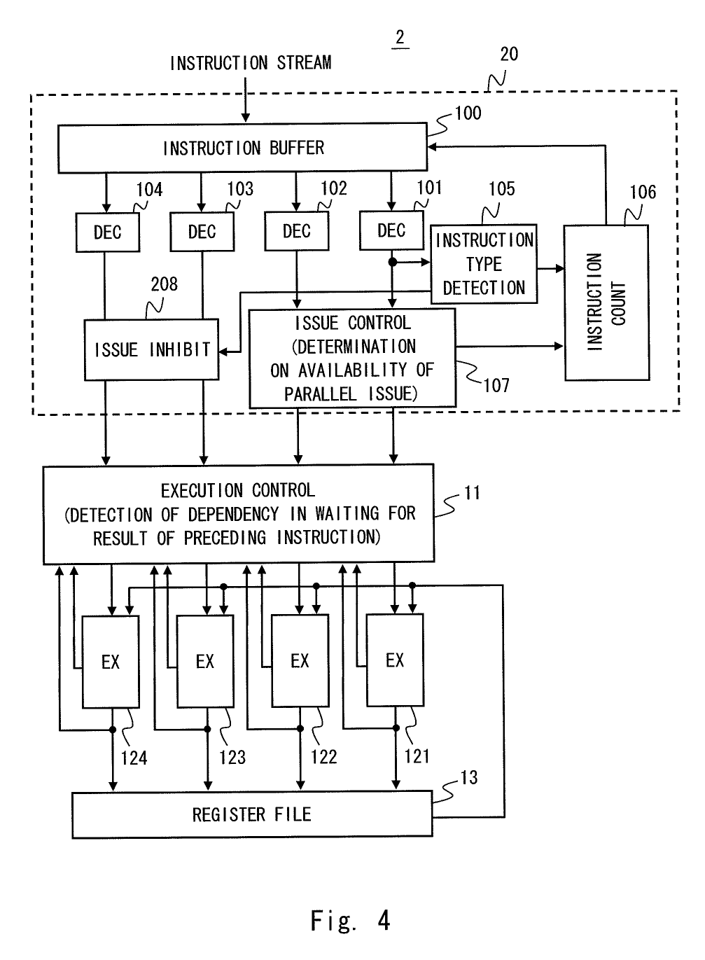

FIG. 4 is a block diagram showing an exemplary configuration of the processor 2. An instruction unit 20 includes an issue inhibit unit 208. The issue inhibit unit 208 controls the issue of the latter two instructions decoded by the instruction decoders 103 and 104 according to the instruction type of the head instruction decoded by the instruction decoder 101. To be specific, when the head instruction is “non-normal instruction”, the issue inhibit unit 208 supplies of the latter two instructions to the execution control unit 11. On the other hand, when the head instruction is “normal instruction”, the issue inhibit unit 208 inhibits the supply of the latter two instructions to the execution control unit 11. The issue inhibit unit 208 may operate depending on an instruction type detection result by the instruction type detection unit 105. The other elements in FIG. 4 other than the issue inhibit unit 208 are similar to those shown in FIG. 1 and thus not redundantly described.

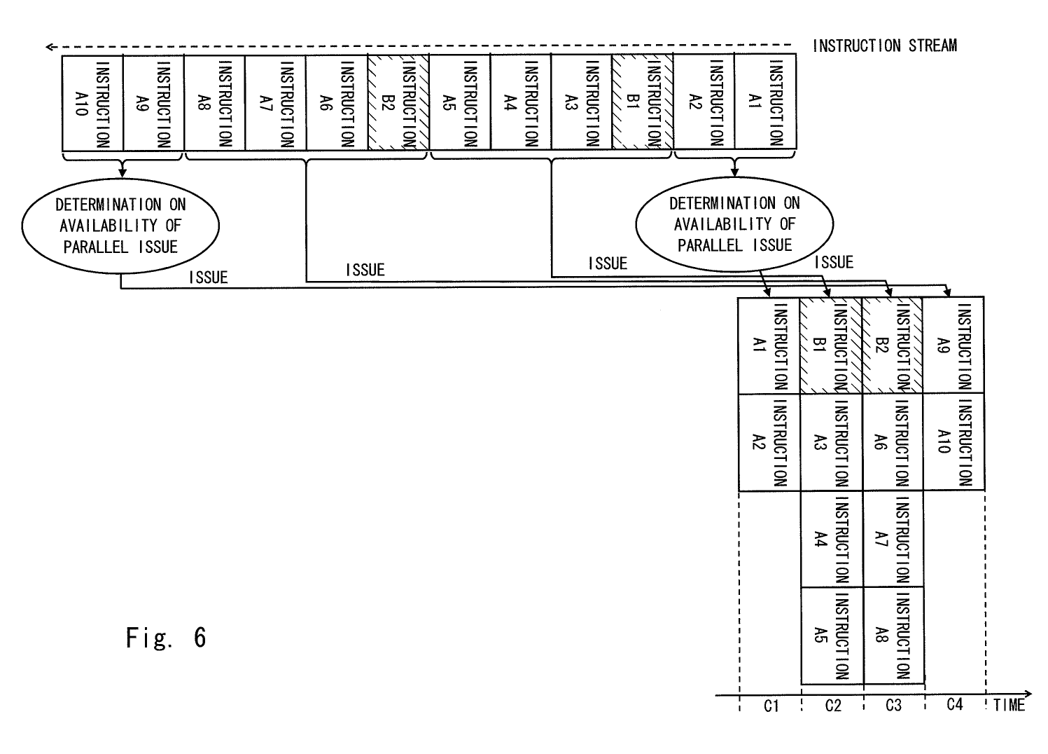

FIG. 6 is a view showing an exemplary operation of the processor 2. The processor 2 sequentially decodes instructions in an instruction stream and issues the decoded instructions in order. The instruction stream shown in FIG. 6 contains instructions A1 to A10 and instructions B1 to B2. Among those instructions, the instruction A1 at the right end in FIG. 6 is an instruction to be executed first. Further, the instructions A1 to A10 are instructions defined as “normal instruction” for which determination about the availability of parallel issue is necessary. The instructions B1 to B2 are instructions defined as “non-normal instruction” for which determination about the availability of parallel issue is unnecessary.

First, the instruction decoders 101 to 104 acquire and decode the instructions A1, A2, B1 and A3. Because the instruction A1 is “normal instruction”, the issue control unit 107 determines the availability of parallel issue of the instructions A1 and A2 based on the dependency between operands of the instructions A1 and A2. In the example of FIG. 6, there is no dependency that constrains parallel issue between the instructions A1 and A2, and those two instructions are issued in parallel (clock cycle C1). On the other hand, the issue of the instructions B1 and A3 decoded by the instruction decoders 103 and 104 is inhibited by the issue inhibit unit 208. Consequently, the two instructions A1 and A2 are issued in the cycle C1. The instruction count unit 106 controls the instruction buffer 100 to fetch new instructions into the buffer area for two instructions, which are issued in this cycle.

Then, the instruction decoders 101 to 104 acquire and decode the instructions B1, A3, A4 and A5. Because the instruction B1 which is the head instruction is “non-normal instruction”, the instruction unit 10 unconditionally issues the four instructions (B1, A3, A4 and A5) in parallel (clock cycle C2). The instruction count unit 106 controls the instruction buffer 100 to fetch new instructions into the buffer area for four instructions, which are issued in this cycle.

Then, the instruction decoders 101 to 104 acquire and decode the instructions B2, A6, A7 and A8. Because the instruction B2 which is the head instruction is “non-normal instruction”, the instruction unit 10 unconditionally issues the four instructions (B2, A6, A7 and A8) in parallel (clock cycle C3). The instruction count unit 106 controls the instruction buffer 100 to fetch new instructions into the buffer area for four instructions, which are issued in this cycle.

The processor 2 according to the exemplary embodiment, like the processor 1, can process instructions for which determination about the availability of parallel issue is necessary and instructions for which it is unnecessary efficiently in succession without an instruction execution suspension period due to program switching, thereby suppressing degradation of the instruction execution performance. Further, the processor 2 enables reduction of the number of instructions to be defined for both “non-normal instruction” and “normal instruction”, it is possible to improve the use efficiency of an operation code area.

### Other Exemplary Embodiments

In the first and second exemplary embodiments of the present invention described above, the case where the maximum number of instructions to be issued in parallel is four is described specifically; however, such embodiments are just by way of illustration as a matter of course. In a processor according to an exemplary embodiment of the present invention, the maximum number of instructions to be issued in parallel may be two or more.

Further, in the first and second exemplary embodiments of the present invention described above, the case where the maximum number of instructions (two instructions to be specific) that can be issued in parallel when adjusting the number of parallel issue instructions based on a determination result about the availability of parallel issue is smaller than the number of instructions (four instructions to be specific) when performing unconditional parallel issue is described. Such a configuration is adequate in light of the amount of processing necessary for determination about the availability of parallel issue. However, the maximum number of instructions that can be issued in parallel when adjusting the number of parallel issue instructions based on a determination result about the availability of parallel issue may be equal to the number of instructions when unconditionally performing parallel issue.

Furthermore, although a processor that implements in-order issue is described specifically in the first and second exemplary embodiments of the present invention, the present invention is applicable also to a processor that implements out-of-order issue. While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A processor comprising:
a plurality of execution units; and
an instruction unit configured to decode an instruction stream and perform instruction issue processing to the plurality of execution units, wherein
the instruction issue processing includes
(a) discriminating whether an instruction is a target instruction for which determination about availability of parallel issue based on dependency among instructions is to be made with respect to each instruction contained in the instruction stream,
(b) when a first instruction contained in the instruction stream is the target instruction, adjusting the number of instructions to be issued in parallel to the plurality of execution units based on a detection result of dependency among the first instruction and at least one subsequent instruction, and
(c) when the first instruction is not the target instruction, issuing an instruction group made up of a predetermined fixed number of instructions including the first instruction in parallel to the plurality of execution units unconditionally regardless of a detection result of dependency among the instruction group.

2. The processor according to claim 1, wherein the fixed number is N (N is an integer of two or greater), and the maximum number of instructions to be issued in parallel in the processing (b) is M (M is a positive integer smaller than N).

3. The processor according to claim 2, further comprising:
a decoding unit that decodes the N number of instructions contained in the instruction stream in parallel in one clock cycle;
an instruction type discrimination unit that discriminates whether a head instruction among the N number of instructions decoded by the decoding unit is the target instruction;
an issue control unit that adjusts the number of instructions to be issued in parallel to the plurality of execution units by making determination about availability of parallel issue on the M number of instructions including the head instruction; and
an issue inhibit unit that inhibits issue of the (N−M) number of instructions excluding the M number of instructions among the N number of instructions to the plurality of execution units when the head instruction is the target instruction.

4. The processor according to claim 1, wherein, when performing the processing (c), the instruction unit issues the instruction group in parallel to the plurality of execution units regardless of whether other instructions excluding the first instruction included in the instruction group is the target instruction.

5. The processor according to claim 1, wherein
an instruction placed at a head of the instruction group contains an instruction code indicative of not being the target instruction, and
at least part of instructions among the instruction group excluding the head of the instruction group contain an instruction code indicative of being the target instruction.

6. The processor according to claim 3, wherein, when the head instruction is not the target instruction, the issue inhibit unit issues the (N-M) number of instructions in parallel to the plurality of execution units regardless of whether the target instruction is included in the (N-M) number of instructions.

7. The processor according to claim 1, further comprising:
an execution control unit that is placed between the instruction unit and the plurality of execution units and configured to detect dependency between instructions issued by the instruction unit and a preceding instruction already being executed in the plurality of execution units and cause execution of an instruction having dependency with the preceding instruction among the instructions issued by the instruction unit to wait.

8. A method of controlling instruction issue to a plurality of execution units included in a processor, comprising steps of:
(a) discriminating whether an instruction is a target instruction for which determination about availability of parallel issue based on dependency among instructions is to be made with respect to each instruction contained in an instruction stream;
(b) when a first instruction contained in the instruction stream is the target instruction, adjusting the number of instructions to be issued in parallel to the plurality of execution units based on a detection result of dependency among the first instruction and at least one subsequent instruction; and
(c) when the first instruction is not the target instruction, issuing an instruction group made up of a predetermined fixed number of instructions including the first instruction in parallel to the plurality of execution units unconditionally regardless of a detection result of dependency among the instruction group.

9. The method according to claim 8, wherein the fixed number is N (N is an integer of two or greater), and the maximum number of instructions to be issued in parallel in the step (b) is M (M is a positive integer smaller than N).

10. The method according to claim 9, wherein the step (b) includes:
discriminating whether a head instruction among the N number of instructions contained in the instruction stream is the target instruction;
adjusting the number of instructions to be issued in parallel to the plurality of execution units by making determination about availability of parallel issue on the M number of instructions including the head instruction; and
inhibiting issue of the (N−M) number of instructions excluding the M number of instructions among the N number of instructions to the plurality of execution units when the head instruction is the target instruction.

11. The method according to claim 8, wherein the step (c) issues the instruction group in parallel to the plurality of execution units regardless of whether other instructions excluding the first instruction included in the instruction group is the target instruction.

12. The method according to claim 8, wherein
an instruction placed at a head of the instruction group contains an instruction code indicative of not being the target instruction, and
at least part of instructions among the instruction group excluding the head of the instruction group contain an instruction code indicative of being the target instruction.

13. The method according to claim 10, wherein the step (c) includes issuing the (N−M) number of instructions in parallel to the plurality of execution units regardless of whether the target instruction is included in the (N−M) number of instructions when the head instruction is not the target instruction.

14. The method according to claim 8, further comprising:
(d) detecting dependency between issued instructions and a preceding instruction already being executed in the plurality of execution units and causing execution of an instruction having dependency with the preceding instruction among the issued instructions to wait.
